(19) United States
(12) Patent Application Publication
(10) Pub. No.: US 2013/0033490 A1
(43) Pub. Date: Feb. 7, 2013

(54) Method, System and Computer Program Product for Reorienting a Stereoscopic Image

(71) Applicant: Buyue Zhang, Plano, TX (US)

(72) Inventor: Buyue Zhang, Plano, TX (US)

(73) Assignee: TEXAS INSTRUMENTS INCORPORATED, Dallas, TX (US)

(21) Appl. No.: 13/559,750

(22) Filed: Jul. 27, 2012

Related U.S. Application Data
(60) Provisional application No. 61/514,989, filed on Aug. 4, 2011.

(51) Int. Cl. G06T 15/00

(52) U.S. Cl. 345/419

(57) ABSTRACT

For reorienting a stereoscopic image of first and second views, a depth map is generated in response to disparities of features between the first and second views. The depth map assigns depths to pixels of the stereoscopic image. In response to the depth map and the second view, a replacement of the first view is synthesized.

### CROSS-REFERENCE TO RELATED APPLICATION

This application claims priority to U.S. Provisional Patent Application Ser. No. 61/514,989, filed Aug. 4, 2011, entitled AUTOMATIC DEPTH CORRECTION FOR STEREOSCOPIC IMAGES AND VIDEOS TAKEN IN THE WRONG ORIENTATION MODE, naming Buyue Zhang as inventor, which is hereby fully incorporated herein by reference for all purposes.

### BACKGROUND

The disclosures herein relate in general to digital image processing, and in particular to a method, system and computer program product for reorienting a stereoscopic image.

For capturing a stereoscopic image, a stereoscopic camera system includes dual imaging sensors, which are spaced apart from one another, namely: (a) a first imaging sensor for capturing a first image of a view for a human's left eye; and (b) a second imaging sensor for capturing a second image of a view for the human's right eye. By displaying the first and second images on a stereoscopic display screen, the stereoscopic image is viewable by the human with three-dimensional (“3D”) effect. Accordingly, in a suitable orientation of the dual imaging sensors, a line between them is substantially parallel to a line between the human's left and right eyes.

However, if the camera system is rotated by 90 degrees from the suitable orientation to an unsuitable orientation, then the line between its dual imaging sensors is substantially perpendicular to the line between the human's left and right eyes. The unsuitable orientation disrupts the human's viewing of the stereoscopic image with 3D effect, and such disruption may cause the human to experience mild-to-significant discomfort (e.g., headaches and/or eye muscle pain). By comparison, if the camera system is constrained to operate in only the suitable orientation, then the stereoscopic image is likewise constrained to have only a particular aspect ratio (e.g., a landscape aspect ratio or a portrait aspect ratio) of the suitable orientation, which limits the camera system's adaptability.

### SUMMARY

For reorienting a stereoscopic image of first and second views, a depth map is generated in response to disparities of features between the first and second views. The depth map assigns depths to pixels of the stereoscopic image. In response to the depth map and the second view, a replacement of the first view is synthesized.

### BRIEF DESCRIPTION OF THE DRAWINGS

FIG. 1 is a block diagram of an information handling system of the illustrative embodiments.

FIG. 2 is a diagram of viewing axes of a human's left and right eyes, relative to a screen of a display device.

FIG. 3 is a diagram of a suitable orientation of dual imaging sensors of the system of FIG. 1, in which a line between the dual imaging sensors is substantially parallel to a line between the human's left and right eyes.

FIG. 4 is a diagram of an unsuitable orientation of the dual imaging sensors of the system of FIG. 1, in which the line between the dual imaging sensors is substantially perpendicular to the line between the human's left and right eyes.

FIG. 5 is an example of a first image for viewing by the human's left eye, as captured by a first one of the dual imaging sensors in the unsuitable orientation.

FIG. 6 is an example of a second image for viewing by the human's right eye, as captured by a second one of the dual imaging sensors in the unsuitable orientation.

FIG. 7 is a flowchart of an operation of a conversion device of the system of FIG. 1, which reorients a stereoscopic image to the suitable orientation for viewing by the human with 3D effect.

FIG. 8 is an example of a depth map for the stereoscopic image of FIGS. 5 and 6.

FIG. 9 is an example of a non-reference image for viewing by the human's left eye, as synthesized by the conversion device of the system of FIG. 1 in response to the reference image of FIG. 6 and the depth map of FIG. 8.

### DETAILED DESCRIPTION

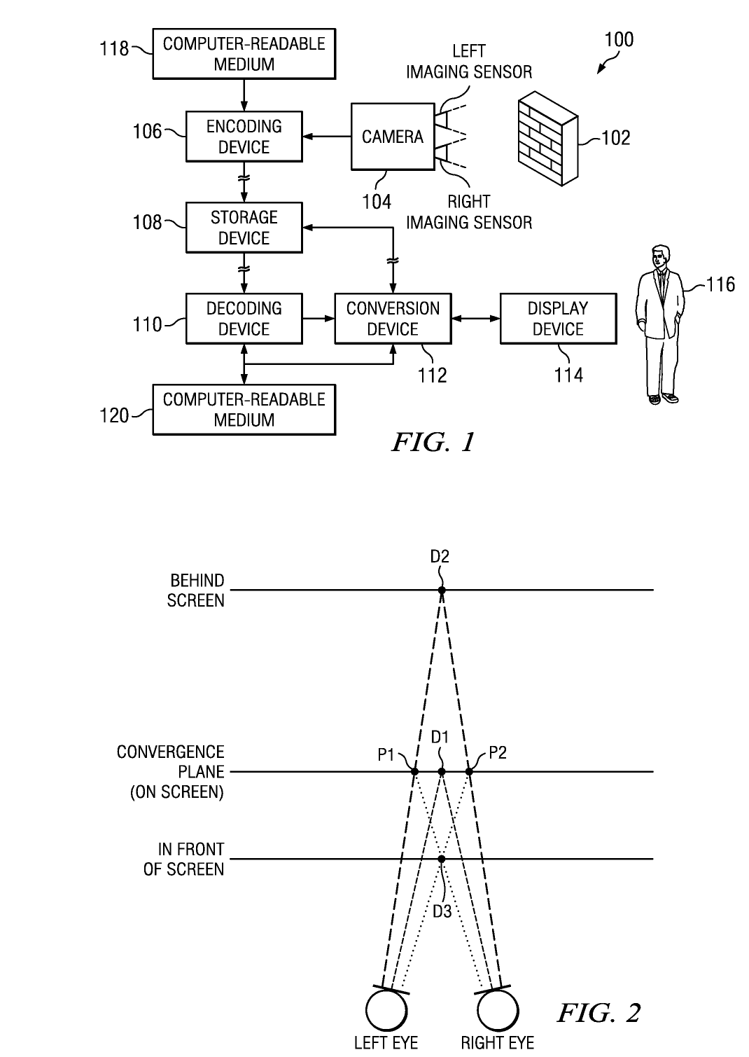

FIG. 1 is a block diagram of an information handling system (e.g., a portable battery-powered electronics device, such as a mobile smartphone, a tablet computing device, a netbook computer, or a laptop computer), indicated generally at 100, of the illustrative embodiments. In the example of FIG. 1, a scene (e.g., including a physical object 102 and its surrounding foreground and background) is viewed by a stereoscopic camera system 104, which: (a) captures and digitizes images of such views; and (b) outputs a video sequence of such digitized (or “digital”) images to an encoding device 106.

As shown in FIG. 1, the camera system 104 includes dual imaging sensors, which are spaced apart from one another, namely: (a) a first imaging sensor for capturing, digitizing and outputting (to the encoding device 106) a first image of a view for a human's left eye; and (b) a second imaging sensor for capturing, digitizing and outputting (to the encoding device 106) a second image of a view for the human's right eye. Accordingly, in a suitable orientation of the dual imaging sensors, a line between them is substantially parallel to a line between the human's left and right eyes. By comparison, in an unsuitable orientation of the dual imaging sensors, a line between them is substantially perpendicular to a line between the human's left and right eyes.

The encoding device 106: (a) encodes such images into a binary logic bit stream; and (b) outputs the bit stream to a storage device 108, which receives and stores the bit stream. A decoding device 110 reads the bit stream from the storage device 108. In response to the bit stream, the decoding device 110: (a) decodes the bit stream into such images; and (b) outputs such decoded images to a conversion device 112.

The conversion device 112 receives the decoded images from the decoding device 110. In response to the decoded images, the conversion device 112 determines whether the decoded images were captured by the dual imaging sensors in the suitable orientation (e.g., by determining whether the decoded images have a landscape aspect ratio or a portrait aspect ratio). In response to determining that the decoded images were captured by the dual imaging sensors in the suitable orientation, the conversion device 112 outputs the decoded images to a display device 114.

By comparison, in response to determining that the decoded images were captured by the dual imaging sensors in the unsuitable orientation, the conversion device 112 automatically converts the decoded images, writes the converted images for storage into the storage device 108, and outputs the converted images to the display device 114, so that such outputting is: (a) substantially concurrent with such conversion by the conversion device 112 in real-time; and/or (b) after the conversion device 112 subsequently reads the converted images from the storage device 108 (e.g., in response to a command that the user 116 specifies via a touchscreen of the display device 114). The conversion device 112 performs such conversion by reorienting the decoded images to the suitable orientation for viewing by the user 116 with 3D effect, as discussed hereinbelow in connection with FIGS. 2-9.

The display device 114: (a) receives the images from the conversion device 112; and (b) in response thereto, displays the received images (e.g., stereoscopic images of the object 102 and its surrounding foreground and background), which are viewable by the user 116 with 3D effect. The display device 114 includes a stereoscopic display screen whose optical components enable viewing by the user 116 with 3D effect. In one example, the display device 114 displays the received images with 3D effect for viewing by the user 116 through special glasses that: (a) filter the first image against being seen by a right eye of the user 116; and (b) filter the second image against being seen by a left eye of the user 116. In another example, the display device 114 is a stereoscopic 3D liquid crystal display device or a stereoscopic 3D organic electroluminescent display device, which displays the received images with 3D effect for viewing by the user 116 without relying on special glasses.

The encoding device 106 performs its operations in response to instructions of a computer-readable program that is stored on a computer-readable medium 118 (e.g., hard disk drive, flash memory card, or other nonvolatile storage device). Similarly, the decoding device 110 and the conversion device 112 perform their operations in response to instructions of a computer-readable program that is stored on a computer-readable medium 120. Also, the computer-readable medium 120 stores a database of information for operations of the decoding device 110 and the conversion device 112.

In an alternative embodiment: (a) the encoding device 106 outputs the bit stream directly to the decoding device 110 via a communication channel (e.g., Ethernet, Internet, or wireless communication channel); and (b) accordingly, the decoding device 110 receives and processes the bit stream directly from the encoding device 106 in real-time. In such alternative embodiment, the storage device 108 either: (a) concurrently receives (in parallel with the decoding device 110) and stores the bit stream from the encoding device 106; or (b) is absent from the system 100. The system 100 is formed by electronic circuitry components for performing the system 100 operations, implemented in a suitable combination of software, firmware and hardware, such as one or more digital signal processors (“DSPs”), microprocessors, discrete logic devices, application specific integrated circuits (“ASICs”), and field-programmable gate arrays (“FPGAs”).

FIG. 2 is a diagram of viewing axes of left and right eyes of the user 116. In the example of FIG. 2, a stereoscopic image is displayed by the display device 114 on a screen (which is a convergence plane where viewing axes of the left and right eyes naturally converge to intersect). The user 116 experiences the 3D effect by viewing the image on the display device 114, so that various features (e.g., objects) appear on the screen (e.g., at a point D1), behind the screen (e.g., at a point D2), and/or in front of the screen (e.g., at a point D3).

Within the stereoscopic image, a feature's disparity is a shift between: (a) such feature's location within the first image; and (b) such feature's corresponding location within the second image. A limit of such disparity is dependent on the camera system 104. For example, if a feature (within the stereoscopic image) is centered on the point D1 within the first image, and likewise centered on the point D1 within the second image, then: (a) such feature's disparity=D1−D1=0; and (b) the user 116 will perceive the feature to appear at the point D1 with zero disparity on the screen, which is a natural convergence distance away from the left and right eyes.

By comparison, if the feature is centered on a point P1 within the first image, and centered on a point P2 within the second image, then: (a) such feature's disparity=P2−P1; and (b) the user 116 will perceive the feature to appear at the point D2 with positive disparity behind the screen, which is greater than the natural convergence distance away from the left and right eyes. Conversely, if the feature is centered on the point P2 within the first image, and centered on the point P1 within the second image, then: (a) such feature's disparity=P1−P2; and (b) the user 116 will perceive the feature to appear at the point D3 with negative disparity in front of the screen, which is less than the natural convergence distance away from the left and right eyes. The amount of the feature's disparity (e.g., horizontal shift of the feature from P1 within the first image to P2 within the second image) is measurable as a number of pixels, so that: (a) positive disparity is represented as a positive number; and (b) negative disparity is represented as a negative number.

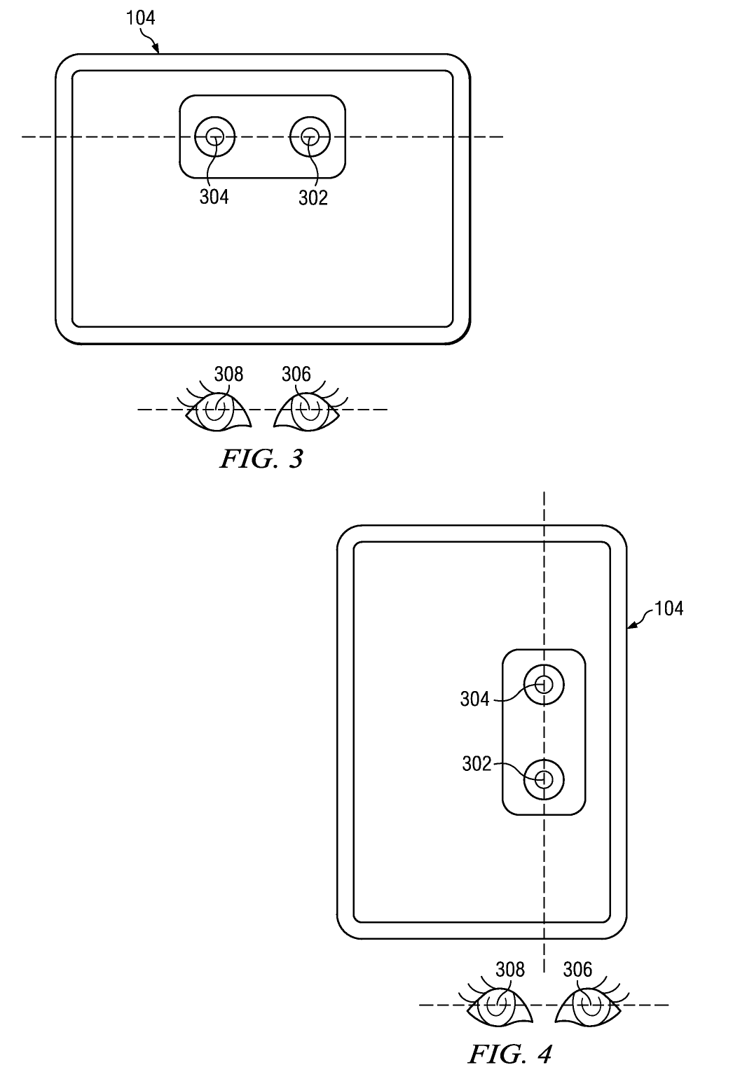

FIG. 3 is a diagram of the suitable orientation of the dual imaging sensors 302 and 304 (of the camera system 104 of FIG. 1), in which a line between the sensors 302 and 304 is substantially parallel to a line between eyes 306 and 308 of the user 116. FIG. 4 is a diagram of the unsuitable orientation of the sensors 302 and 304, in which the line between the sensors 302 and 304 is substantially perpendicular to the line between the eyes 306 and 308. As shown in FIG. 4, the camera system 104 is rotated by 90 degrees from the suitable orientation (FIG. 3) to the unsuitable orientation (FIG. 4). In this example, the camera system 104 captures and digitizes: (a) images with a landscape aspect ratio while the sensors 302 and 304 have the suitable orientation; and (b) images with a portrait aspect ratio while the sensors 302 and 304 have the unsuitable orientation. In a different example, the camera system 104 captures and digitizes: (a) images with a portrait aspect ratio while the sensors 302 and 304 have the suitable orientation; and (b) images with a landscape aspect ratio while the sensors 302 and 304 have the unsuitable orientation.

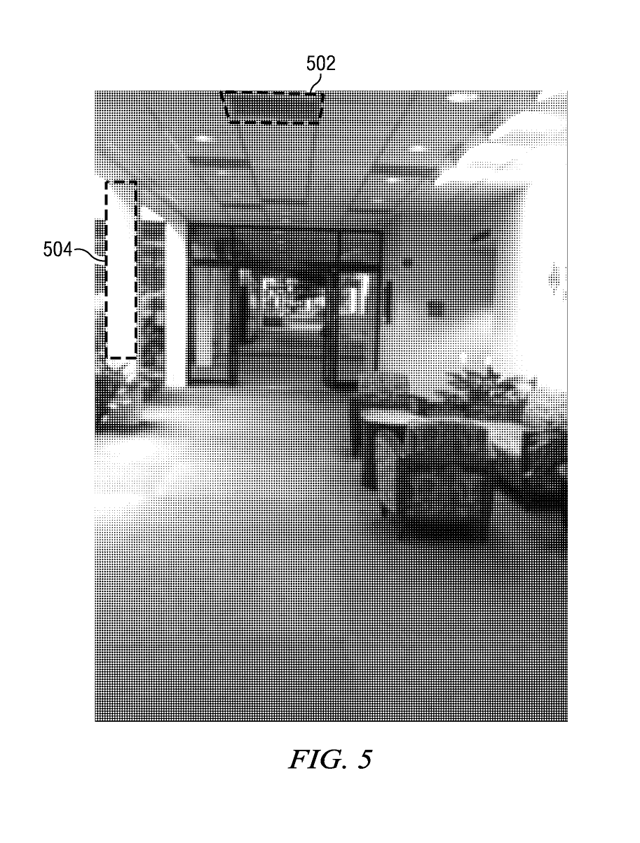

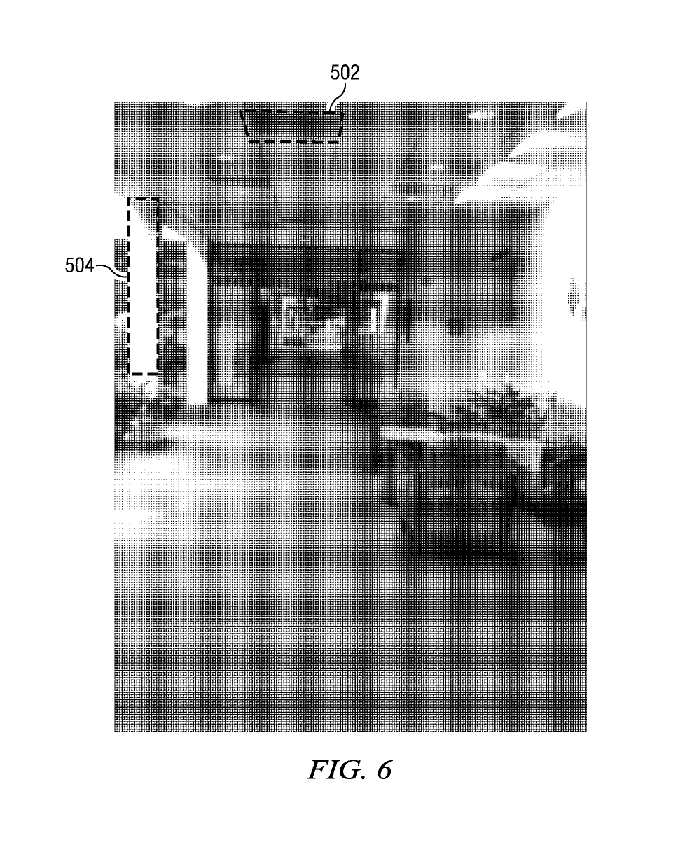

FIG. 5 is an example of a first image for viewing by the left eye 306, as captured by the imaging sensor 302 in the unsuitable orientation of FIG. 4. FIG. 6 is an example of a second image for viewing by the right eye 308, as captured by the imaging sensor 304 in the unsuitable orientation of FIG. 4. For example, in association with one another, the first image (FIG. 5) and the second image (FIG. 6) are contemporaneously (e.g., simultaneously) captured, digitized and output (to the encoding device 106) by the imaging sensors 302 and 304, respectively.

Accordingly, the first image (FIG. 5) and its associated second image (FIG. 6) are a matched pair, which correspond to one another, and which together form a stereoscopic image for viewing by the user 116 with 3D effect on the display device 114. In the example of FIGS. 5 and 6, disparities (of various features between the first and second images) exist in a vertical direction, which is parallel to the line between the sensors 302 and 304 in the unsuitable orientation of FIG. 4. As shown in FIGS. 5 and 6, a ceiling tile 502 and a pillar 504 appear lower in the second image (FIG. 6) than in the first image (FIG. 5).

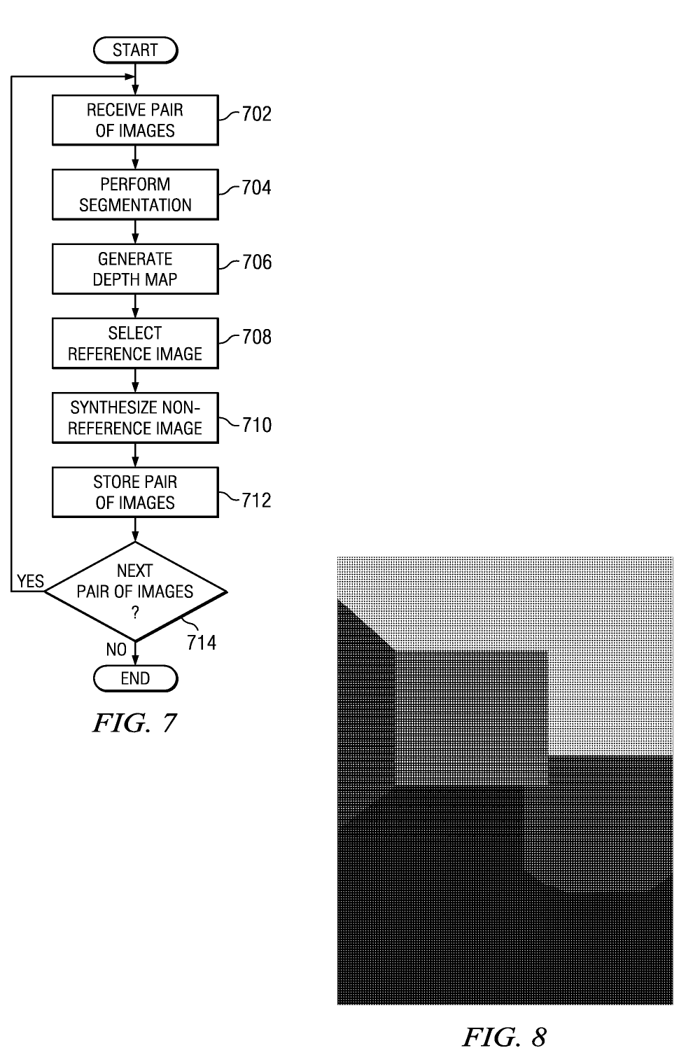

FIG. 7 is a flowchart of an operation of the conversion device 112, which reorients a stereoscopic image to the suitable orientation for viewing by the user 116 with 3D effect on the display device 114. The operation begins at a step 702, at which the conversion device 112: (a) receives a matched pair of first and second images (which together form a stereoscopic image) from the decoding device 110; and (b) determines whether the stereoscopic image was captured by the dual imaging sensors in the unsuitable orientation. If the conversion device 112 determines that the stereoscopic image was captured by the dual imaging sensors in the unsuitable orientation, then the operation continues to a next step 704.

Optionally, at the step 704, in response to the database of information (e.g., training information) from the computer-readable medium 120, the conversion device 112: (a) identifies (e.g., detects and classifies) various low level features (e.g., colors, edges, textures, focus/blur, object sizes, gradients, and positions) and high level features (e.g., faces, bodies, sky, foliage, and other objects) within the stereoscopic image, such as by performing a mean shift clustering operation to segment the stereoscopic image into regions; and (b) computes disparities of such features (between the first image and its associated second image, which together form the stereoscopic image). At a next step 706, the conversion device 112 automatically generates a depth map that assigns respective depth values to pixels of the stereoscopic image (e.g., in response to such disparities).

FIG. 8 is an example of a manually generated depth map for the stereoscopic image of FIGS. 5 and 6. In the example of FIG. 8: (a) one region (“foreground region”) includes one or more features that were most proximate to the camera system 104, so that all pixels within the foreground region (“foreground pixels”) have a relative depth=0 in the depth map; and (b) by comparison, other regions (“background regions”) include one or more features that were less proximate to (e.g., more distant from) the camera system 104, so that all pixels within the background regions (“background pixels”) have relative depths>0 in the depth map. Also, in the example of FIG. 8, the depths are assigned in discrete tiers relative to the foreground region, so that all background pixels within a particular background region have a same depth as one another in the depth map. Accordingly, in the example of FIG. 8, the stereoscopic image is segmented into a foreground region and four (4) background regions, so that: (a) the foreground region has a first relative depth=0 in the depth map; and (b) the four background regions have second, third, fourth and fifth relative depths, respectively, in the depth map.

Referring again to FIG. 7, after the step 706, the operation continues to a step 708. At the step 708, the conversion device 112 selects a reference image from among the first and images. In the example of FIGS. 5 and 6, the conversion device 112 selects the second image (FIG. 6) as the reference image.

At a next step 710, in response to the reference image and the depth map, the conversion device 112 performs a depth-based image rendering (“DBIR”) operation for synthesizing a non-reference image as a replacement for the first image (e.g., a replacement of the view for the left eye 306). In one embodiment, the conversion device 112 synthesizes the non-reference image by: (a) for a pixel P_{xy} whose respective depth D_{xy}=0 in the depth map, copying such pixel P_{xy} from its respective X-Y coordinate of the reference image to a collocated X-Y coordinate of the non-reference image; and (b) for a pixel P_{xy} whose respective depth D_{xy}>0 in the depth map, copying such pixel P_{xy} from its respective X-Y coordinate of the reference image to a different X-Y coordinate of the non-reference image. The conversion device 112 computes the different X-Y coordinate in response to (e.g., in proportion to) D_{xy}. Accordingly, in comparison to such pixel P_{xy}'s respective X-Y coordinate within the reference image, such pixel P_{ry}'s respective X- Y coordinate within the non-reference image is shifted in a horizontal direction (e.g., either left or right) by a variable integer number Shift_{xy} of pixels, so that: (a) Shift_{xy}=J·D_{xy}, rounded to the nearest integer; and (b) J is a stereoscopic conversion constant.

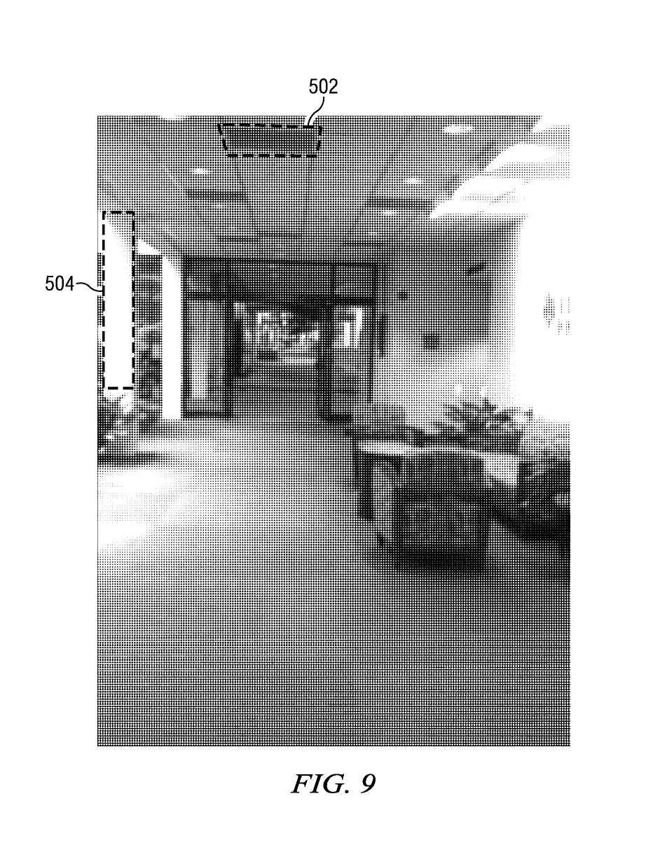

FIG. 9 is an example of the non-reference image for viewing by the left eye 306, as synthesized by the conversion device 112 at the step 710 in response to the reference image of FIG. 6 and the depth map of FIG. 8. In the example of FIGS. 6 and 9, disparities (of various features between the reference and non-reference images) exist in a horizontal direction, which is substantially parallel to the line between the eyes 306 and 308 of FIG. 4. As shown in FIGS. 6 and 9, the ceiling tile 502 and the pillar 504 are shifted left in the non-reference image (FIG. 9) versus its associated reference image (FIG. 6).

By comparison, the foreground region (e.g., carpeted flooring in the bottom half of FIGS. 6 and 9) is unshifted between the non-reference image and its associated reference image. Accordingly, the non-reference image and its associated reference image are a matched pair, which correspond to one another, and which together form a reoriented version of the stereoscopic image. In synthesizing the non-reference image, the conversion device 112 performs suitable operations for removing holes that could have otherwise appeared in the non-reference image (e.g., holes that could have resulted from differences in depth values alongside boundaries between neighboring regions within the depth map, such as neighboring regions within the depth map of FIG. 8).

Referring again to FIG. 7, after the step 710, the operation continues to a step 712. At the step 712, the conversion device 112 writes the non-reference image and its associated reference image for storage into the storage device 108. In that manner, by substituting the non-reference image as a replacement for the first image (e.g., a replacement of the view for the left eye 306), the conversion device 112 reorients the stereoscopic image to the suitable orientation for viewing by the user 116 with 3D effect on the display device 114.

At a next step 714, the conversion device 112 determines whether a next stereoscopic image (e.g., within a video sequence of digitized pictures) remains to be so reoriented. If the conversion device 112 determines that a next stereoscopic image remains to be so reoriented, then operation returns from the step 714 to the step 702 for such next stereoscopic image. Conversely, if the conversion device 112 determines that no stereoscopic image remains to be so reoriented, then the operation of FIG. 7 ends. Referring again to the step 702, if the conversion device 112 determines that a particular stereoscopic image was captured by the dual imaging sensors in the suitable orientation, then the operation jumps from the step 702 to the step 714, so that the steps 704-712 are skipped for that particular stereoscopic image.

Referring again to the step 706, the conversion device 112 generates the depth map in response to information from the computer-readable medium 120, and in response to either: (a) in the illustrative embodiments, disparities in a vertical direction; or (b) in an alternative embodiment, disparities in a horizontal direction. In such alternative embodiment, the conversion device 112: (a) before performing the step 706, rotates the first and second images to a different orientation that is substantially perpendicular to the pre-rotation orientation (e.g., rotates the first and second images counterclockwise by 90 degrees), so that disparities in a horizontal direction of the post-rotation images are the same as disparities in a vertical direction of the pre-rotation images; and (b) after performing the step 706, rotates the depth map to align with the pre-rotation orientation of the first and second images (e.g., rotates the depth map clockwise by 90 degrees).

In another alternative embodiment, the encoding device 106 includes a conversion device identical to the conversion device 112. In such alternative embodiment, the encoding device 106: (a) receives the images from the camera system 104; and (b) determines whether the received images were captured by the dual imaging sensors in the suitable orientation (e.g., in response to signals from an accelerometer of the camera system 104). In response to determining that the received images were captured by the dual imaging sensors in the suitable orientation, the encoding device 106: (a) encodes the received images into the binary logic bit stream; and (b) writes the bit stream for storage into the storage device 108. By comparison, in response to determining that the received images were captured by the dual imaging sensors in the unsuitable orientation, the encoding device 106 automatically: (a) converts the received images by reorienting the received images to the suitable orientation for viewing by the user 116 with 3D effect, as discussed hereinabove in connection with FIGS. 2-9; (b) encodes the converted images into the binary logic bit stream; and (c) writes the bit stream for storage into the storage device 108, so that such writing is substantially concurrent with such conversion by the encoding device 106 in real-time.

In the illustrative embodiments, a computer program product is an article of manufacture that has: (a) a computer-readable medium; and (b) a computer-readable program that is stored on such medium. Such program is processable by an instruction execution apparatus (e.g., system or device) for causing the apparatus to perform various operations discussed hereinabove (e.g., discussed in connection with a block diagram). For example, in response to processing (e.g., executing) such program's instructions, the apparatus (e.g., programmable information handling system) performs various operations discussed hereinabove. Accordingly, such operations are computer-implemented.

Such program (e.g., software, firmware, and/or microcode) is written in one or more programming languages, such as: an object-oriented programming language (e.g., C++); a procedural programming language (e.g., C); and/or any suitable combination thereof. In a first example, the computer-readable medium is a computer-readable storage medium. In a second example, the computer-readable medium is a computer-readable signal medium.

A computer-readable storage medium includes any system, device and/or other non-transitory tangible apparatus (e.g., electronic, magnetic, optical, electromagnetic, infrared, semiconductor, and/or any suitable combination thereof) that is suitable for storing a program, so that such program is processable by an instruction execution apparatus for causing the apparatus to perform various operations discussed hereinabove. Examples of a computer-readable storage medium include, but are not limited to: an electrical connection having one or more wires; a portable computer diskette; a hard disk; a random access memory (“RAM”); a read-only memory (“ROM”); an erasable programmable read-only memory (“EPROM” or flash memory); an optical fiber; a portable compact disc read-only memory (“CD-ROM”); an optical storage device; a magnetic storage device; and/or any suitable combination thereof.

A computer-readable signal medium includes any computer-readable medium (other than a computer-readable storage medium) that is suitable for communicating (e.g., propagating or transmitting) a program, so that such program is processable by an instruction execution apparatus for causing the apparatus to perform various operations discussed hereinabove. In one example, a computer-readable signal medium includes a data signal having computer-readable program code embodied therein (e.g., in baseband or as part of a carrier wave), which is communicated (e.g., electronically, electromagnetically, and/or optically) via wireline, wireless, optical fiber cable, and/or any suitable combination thereof.

Although illustrative embodiments have been shown and described by way of example, a wide range of alternative embodiments is possible within the scope of the foregoing disclosure.

What is claimed is:

1. A method performed by an information handling system for reorienting a stereoscopic image of first and second views, the method comprising:
in response to disparities of features between the first and second views, generating a depth map that assigns depths to pixels of the stereoscopic image; and
in response to the depth map and the second view, synthesizing a replacement of the first view.

2. The method of claim 1, wherein generating the depth map includes: generating the depth map in response to disparities in a first direction of the features between the first and second views.

3. The method of claim 2, wherein the disparities are first disparities, and wherein synthesizing the replacement includes: in response to the depth map and the second view, synthesizing the replacement by synthesizing second disparities in a second direction of the features between the replacement and the second view, wherein the second direction is substantially perpendicular to the first direction.

4. The method of claim 3, wherein the second direction is substantially parallel to a line between eyes of a user.

5. The method of claim 4, wherein the replacement is for viewing by a left eye of the user, and wherein the second view is for viewing by a right eye of the user.

6. The method of claim 1, wherein generating the depth map and synthesizing the replacement include generating the depth map and synthesizing the replacement in response to determining that the stereoscopic image has a particular aspect ratio.

7. The method of claim 6, wherein the particular aspect ratio is a portrait aspect ratio.

8. The method of claim 1, wherein the first and second views have a first orientation, and wherein generating the depth map includes:
rotating the first and second views to a second orientation that is substantially perpendicular to the first orientation;
generating the depth map in response to disparities of the features between the first and second views in the second orientation; and
rotating the depth map to align with the first orientation of the first and second views.

9. The method of claim 1, and comprising:
identifying the features within the stereoscopic image.

10. The method of claim 1, and comprising:
segmenting the stereoscopic image into regions, including a foreground region and at least one background region, wherein the depth map assigns the depths in discrete tiers relative to the foreground region, so that all pixels within a particular region have a same depth as one another in the depth map.

11. A system for reorienting a stereoscopic image of first and second views, the system comprising:
at least one device for: in response to disparities of features between the first and second views, generating a depth map that assigns depths to pixels of the stereoscopic image; and, in response to the depth map and the second view, synthesizing a replacement of the first view.

12. The system of claim 11, wherein generating the depth map includes: generating the depth map in response to disparities in a first direction of the features between the first and second views.

13. The system of claim 12, wherein the disparities are first disparities, and wherein synthesizing the replacement includes: in response to the depth map and the second view, synthesizing the replacement by synthesizing second disparities in a second direction of the features between the replacement and the second view, wherein the second direction is substantially perpendicular to the first direction.

14. The system of claim 13, wherein the second direction is substantially parallel to a line between eyes of a user.

15. The system of claim 14, wherein the replacement is for viewing by a left eye of the user, and wherein the second view is for viewing by a right eye of the user.

16. The system of claim 11, wherein generating the depth map and synthesizing the replacement include generating the depth map and synthesizing the replacement in response to determining that the stereoscopic image has a particular aspect ratio.

17. The system of claim 16, wherein the particular aspect ratio is a portrait aspect ratio.

18. The system of claim 11, wherein the first and second views have a first orientation, and wherein generating the depth map includes:
rotating the first and second views to a second orientation that is substantially perpendicular to the first orientation;
generating the depth map in response to disparities of the features between the first and second views in the second orientation; and
rotating the depth map to align with the first orientation of the first and second views.

19. The system of claim 11, wherein the at least one device is for identifying the features within the stereoscopic image.

20. The system of claim 11, wherein the at least one device is for segmenting the stereoscopic image into regions, including a foreground region and at least one background region; and wherein the depth map assigns the depths in discrete tiers relative to the foreground region, so that all pixels within a particular region have a same depth as one another in the depth map.

21. A computer program product for reorienting a stereoscopic image of first and second views, the computer program product comprising:
a tangible computer-readable storage medium; and
a computer-readable program stored on the tangible computer-readable storage medium, wherein the computer-readable program is processable by an information handling system for causing the information handling system to perform operations including: in response to disparities of features between the first and second views, generating a depth map that assigns depths to pixels of the stereoscopic image; and, in response to the depth map and the second view, synthesizing a replacement of the first view.

22. The computer program product of claim 21, wherein generating the depth map includes: generating the depth map in response to disparities in a first direction of the features between the first and second views.

23. The computer program product of claim 22, wherein the disparities are first disparities, and wherein synthesizing the replacement includes: in response to the depth map and the second view, synthesizing the replacement by synthesizing second disparities in a second direction of the features between the replacement and the second view, wherein the second direction is substantially perpendicular to the first direction.

24. The computer program product of claim 23, wherein the second direction is substantially parallel to a line between eyes of a user.

25. The computer program product of claim 24, wherein the replacement is for viewing by a left eye of the user, and wherein the second view is for viewing by a right eye of the user.

26. The computer program product of claim 21, wherein generating the depth map and synthesizing the replacement include generating the depth map and synthesizing the replacement in response to determining that the stereoscopic image has a particular aspect ratio.

27. The computer program product of claim 26, wherein the particular aspect ratio is a portrait aspect ratio.

28. The computer program product of claim 21, wherein the first and second views have a first orientation, and wherein generating the depth map includes:
rotating the first and second views to a second orientation that is substantially perpendicular to the first orientation;
generating the depth map in response to disparities of the features between the first and second views in the second orientation; and
rotating the depth map to align with the first orientation of the first and second views.

29. The computer program product of claim 21, wherein the operations include: identifying the features within the stereoscopic image.

30. The computer program product of claim 21, wherein the operations include: segmenting the stereoscopic image into regions, including a foreground region and at least one background region, wherein the depth map assigns the depths in discrete tiers relative to the foreground region, so that all pixels within a particular region have a same depth as one another in the depth map.
